(19) United States
(12) Patent Application Publication
(10) Pub. No.: US 2014/0205185 A1
(43) Pub. Date: Jul. 24, 2014

(54) IMAGE PROCESSING DEVICE, IMAGE PICKUP DEVICE, AND IMAGE DISPLAY DEVICE

(71) Applicants: Nao Tokui, Osaka-shi (JP); Kei Tokui, Osaka-shi (JP)

(72) Inventors: Nao Tokui, Osaka-shi (JP); Kei Tokui, Osaka-shi (JP)

(73) Assignee: Sharp Kabushiki Kaisha, Osaka-shi, Osaka (JP)

(21) Appl. No.: 14/342,581

(22) PCT Filed: Jul. 3, 2012
(86) PCT No.: PCT/JP2012/066986

§ 371 Date: Mar. 4, 2014

(30) Foreign Application Priority Data
Sep. 13, 2011 (JP) 2011-199168
Feb. 24, 2012 (JP) 2012-038205

(51) Int. Cl. G06K 9/62; G06K 9/00

(52) U.S. Cl. CPC G06K 9/6201; G06K 9/00201
USPC 382/154

(57) ABSTRACT

With an image processing device of the present invention, the image processing device, an image pickup device, and an image display device are provided which can correct a spatial distortion generated in taking and displaying a stereoscopic image, and which can present a high-quality image with a stereoscopic feel. The image processing device comprises an information acquisition unit (20) that obtains disparity information calculated from a stereoscopic image, image-pickup condition information when the stereoscopic image is taken, and display condition information of a display unit that displays the stereoscopic image, and an image processing unit (30) that converts a disparity of the stereoscopic image. The image processing unit (30) converts the disparity in a direction of compressing the disparity or in a direction of enlarging the disparity in accordance with the image-pickup condition information, the display condition information, and the disparity information, which are obtained by the information acquisition unit (20), such that the direction of converting the disparity is reversed between when a binocular spacing contained in the display condition information is larger than a camera spacing contained in the image-pickup condition information and when the binocular spacing is smaller than the camera spacing.

### TECHNICAL FIELD

The present invention relates to an image processing device, an image pickup device, and an image display device, which are each used to generate a stereoscopic image.

### BACKGROUND ART

There is known a multi-view image pickup device including a plurality of image pickup means. The multi-view image pickup device realizes sophisticated image pickup, such as taking a stereoscopic image and a panoramic image, by processing images taken by the plurality of image pickup means. In the case of viewing the stereoscopic image with a stereoscopic image display device, a stereoscopic vision can be provided by displaying a left-eye adapted image for a left eye and a right-eye adapted image for a right eye, respectively. Such a stereoscopic vision can be provided with stereoscopic display utilizing a disparity among a plurality of images that are obtained by taking images of one object from different positions.

When images taken by the above-described multi-view image pickup device from two visual points are displayed to be viewed on the stereoscopic image display device, a viewing person sometimes percepts that the spatial distance between the background and the object is narrower, or that the object is thinner than in the actual scene. Such a phenomenon is attributable to a spatial distortion specific to the stereoscopic image, which distortion is generated in taking and displaying the image, and that phenomenon is one factor causing the viewing person to feel awkward when viewing the stereoscopic image. There is a method to quantify the distortion specific to the stereoscopic image by employing parameters in taking and displaying the image. According to Patent Literature (PTL) 1, the above-described method can not only simplify the configuration of a system for generating the stereoscopic image, but also confirm unnaturalness attributable to a geometrical spatial distortion without needing complex operations when right and left images are taken.

### CITATION LIST

### Patent Literature

PTL 1: Japanese Unexamined Patent Application Publication No. 2005-26756

### SUMMARY OF INVENTION

### Technical Problem

The geometrical spatial distortion can be confirmed with the method according to PTL 1, but PTL 1 does not disclose a method of correcting the spatial distortion in practice. Furthermore, because the spatial distance between the background and the object is enlarged by correcting the spatial distortion, another problem arises in that a thinner appearance of the object is further emphasized.

The present invention has been accomplished in view of the above-mentioned problems, and an object of the present invention is to provide an image processing device, an image pickup device, and an image display device, which can correct a spatial distortion generated in taking and displaying a stereoscopic image, and which can present a high-quality image with a stereoscopic effect.

### Solution to Problem

To solve the above-mentioned problems, the present invention includes technical means as follows.

According to first technical means of the present invention, there is provided an image processing device including an information acquisition unit that obtains disparity information calculated from a stereoscopic image, image-pickup condition information when the stereoscopic image is taken, and display condition information of a display unit that displays the stereoscopic image, and an image processing unit that converts a disparity of the stereoscopic image, wherein the image processing unit converts the disparity in a direction of compressing the disparity or in a direction of enlarging the disparity in accordance with the image-pickup condition information, the display condition information, and the disparity information, which are obtained by the information acquisition unit, such that the direction of converting the disparity is reversed between when a binocular spacing contained in the display condition information is larger than a camera spacing contained in the image-pickup condition information and when the binocular spacing is smaller than the camera spacing.

According to second technical means, in the first technical means, the image processing unit reverses the direction of converting the disparity between when a disparity of an output stereoscopic image output from the image processing device is positive and when the disparity of the output stereoscopic image is negative.

According to third technical means, in the first or second technical means, when a difference between adjacent disparities contained in the disparity information is within a predetermined range and the difference between the adjacent disparities is increased in the disparity information after the conversion, the image processing unit interpolates the disparity such that the difference between the adjacent disparities reduces.

According to fourth technical means, in any one of the first to third technical means, the image processing unit holds a disparity range of the stereoscopic image after the disparity conversion within a predetermined range.

According to fifth technical means, in the fourth technical means, the predetermined range is given as a range between a disparity, which is calculated in accordance with the image-pickup condition information, the display condition information, and the disparity information, and an input disparity.

According to sixth technical means, in any one of the first to fourth technical means, the image processing unit executes the disparity conversion on a disparity smaller than a disparity of a main object that is designated or detected by a predetermined method.

According to seventh technical means, in the sixth technical means, the disparity output through the disparity conversion is held within a range expressed by the disparity, which is calculated in accordance with the image-pickup condition information, the display condition information, and the disparity information, and by the input disparity.

According to eighth technical means, in any one of the first to fourth technical means, the image processing unit converts the disparity of the disparity image such that a disparity of a main object, which is designated or detected by a predetermined method, comes close to 0.

According to ninth technical means, in the eighth technical means, the image processing unit makes the disparity come close to 0 for an object present at a distance of a convergence point that is calculated from the image-pickup condition information of the image pickup unit.

According to tenth technical means, there is provided an image display device including the image processing device according to any one of the first to ninth technical means.

According to eleventh technical means, there is provided an image pickup device including the image processing device according to any one of the first to ninth technical means.

### Advantageous Effects of Invention

According to the present invention, the spatial distortion generated in taking and displaying the stereoscopic image can be corrected, and the high-quality image with the stereoscopic effect can be provided.

### BRIEF DESCRIPTION OF DRAWINGS

FIG. 1 is a block diagram illustrating a first embodiment of an image display device including an image processing device according to the present invention.

FIG. 2 is an illustration to explain image pickup conditions when a stereoscopic image is taken.

FIG. 3 is an illustration representing display conditions when a stereoscopic image is viewed.

FIG. 4 illustrates a left-eye adapted image constituting a stereoscopic image and disparity information corresponding to the left-eye adapted image.

FIG. 5 illustrates an image pickup distance L_{b} when the stereoscopic image of FIG. 4 is taken, and a perceptual distance L_{d} when the stereoscopic image is viewed on a stereoscopic image display device.

FIG. 6 is an illustration to explain a state where the perceptual distance L_{d} becomes longer than a visual distance Lₛ and the stereoscopic image is perceived on the side farther than a display plane, when the stereoscopic image is viewed.

FIG. 7 is an illustration to explain the relationship between the image pickup distance L_{b} and the perceptual distance L_{d}.

FIG. 8 illustrates a disparity conversion table.

FIG. 9 is graph plotting the relationship between an input disparity and an output disparity after conversion using the disparity conversion table.

FIG. 10 illustrates an example in which an object structure correction portion is applied to disparity information.

FIG. 11 is a graph to explain details of an object structure correction process.

FIG. 12 is another graph to explain details of the object structure correction process.

FIG. 13 is an illustration to explain results of pixel conversion in the object structure correction process.

FIG. 14 is an illustration representing the relationship between the image pickup distance L_{b} and the perceptual distance L_{d} when perceived position adjustment is performed.

FIG. 15 is another illustration representing the relationship between the image pickup distance L_{b} and the perceptual distance L_{d} when the perceived position adjustment is performed.

FIG. 16 is still another illustration representing the relationship between the image pickup distance L_{b} and the perceptual distance L_{d} when the perceived position adjustment is performed.

FIG. 17 is graph plotting the relationship between an input disparity and an output disparity after conversion using a disparity conversion table.

FIG. 18 is a block diagram illustrating an embodiment of an image pickup device including the image processing device according to the present invention.

FIG. 19 is an illustration to explain a convergence angle of an image pickup unit.

FIG. 20 is an illustration to explain the relationship between the image pickup distance and the perceptual distance L_{d} when an object at a position of a convergence point is perceived on the display plane.

FIG. 21 is a graph illustrating a fourth embodiment of the image display device including the image processing device according to the present invention.

FIG. 22 is a graph to explain the reason that a sufficient stereoscopic effect is not obtained with the disparity conversion in the first to third embodiments when a main object is present in the foreground.

FIG. 23 is a graph representing that the perceptual distance after the disparity conversion is held within a predetermined range.

FIG. 24 is a graph to explain a disparity conversion method when the position of a main object is specified.

FIG. 25 is a graph representing that, when the position of a main object is specified, the stereoscopic effect for an object, which is positioned on the rear side of the main object, can be changed by adjusting a weighing parameter.

### DESCRIPTION OF EMBODIMENTS

The present invention will be described in detail below with reference to the drawings. It is to be noted that configurations in the drawings are illustrated in an exaggerated manner for easier understanding, and that distances and sizes illustrated in the drawings are different from actual ones.

### First Embodiment

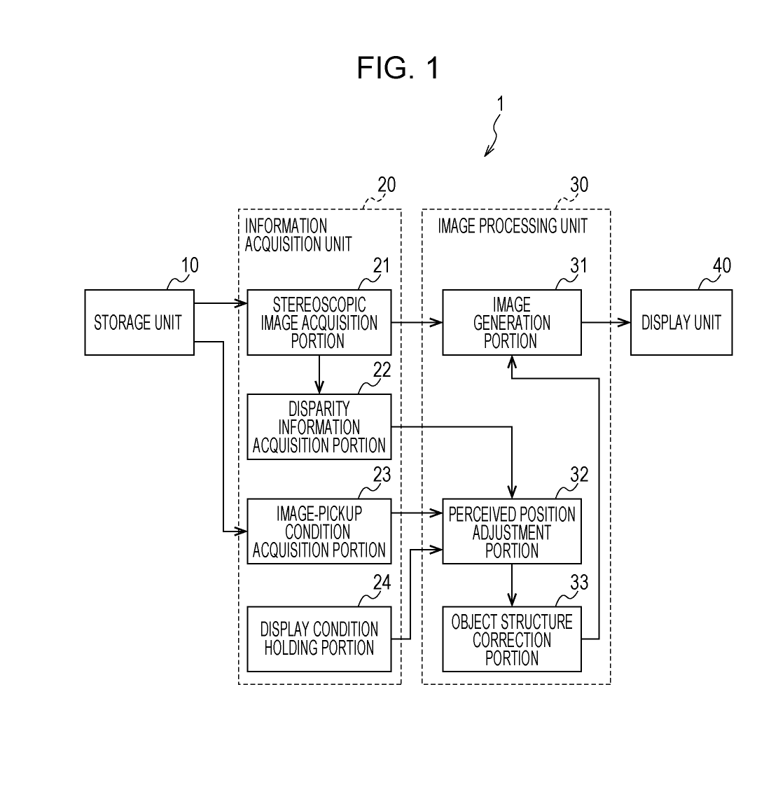

FIG. 1 is a block diagram illustrating a first embodiment of an image display device including an image processing device according to the present invention. The image display device 1 of this embodiment includes a storage unit 10, an information acquisition unit 20, an image processing unit 30, and a display unit 40. The information acquisition unit 20 and the image processing unit 30 correspond to the image processing device of the present invention.

The storage unit 10 is constituted as a hard disk drive or a recording medium, e.g., a memory card, which stores a stereoscopic image and image-pickup condition information when the stereoscopic image is taken. The information acquisition unit 20 obtains, from the storage unit 10, the stereoscopic image and the image-pickup condition information associated with the stereoscopic image.

The image processing unit 30 executes image processing of the stereoscopic image obtained by the information acquisition unit 20. The display unit 40 obtains the stereoscopic image from the image processing unit 30 and displays the stereoscopic image by a stereoscopic image display method described later.

The information acquisition unit 20 and the image processing unit 30 will be described in more detail below.

The information acquisition unit 20 in this embodiment includes a stereoscopic image acquisition portion 21, a disparity information acquisition portion 22, an image-pickup condition acquisition portion 23, and a display condition holding portion 24.

The stereoscopic image acquisition portion 21 obtains the stereoscopic image from the storage unit 10 and sends the stereoscopic image to the image processing unit 30. The disparity information acquisition portion 22 obtains the stereoscopic image from the storage unit 10, detects a disparity per predetermined unit, such as per pixel, and generates disparity information representing the detected disparity in units of pixels. Here, of a left-eye adapted image and a right-eye adapted image constituting the stereoscopic image, the left-eye adapted image is used as a basis for disparity calculation. In other words, the disparity information corresponding to the left-eye adapted image is calculated. The disparity information acquisition portion 22 sends the calculated disparity information to the image processing unit 30.

The image-pickup condition acquisition portion 23 obtains the image-pickup condition information corresponding to the stereoscopic image from the storage unit 10 and sends the image-pickup condition information to the image processing unit 30.

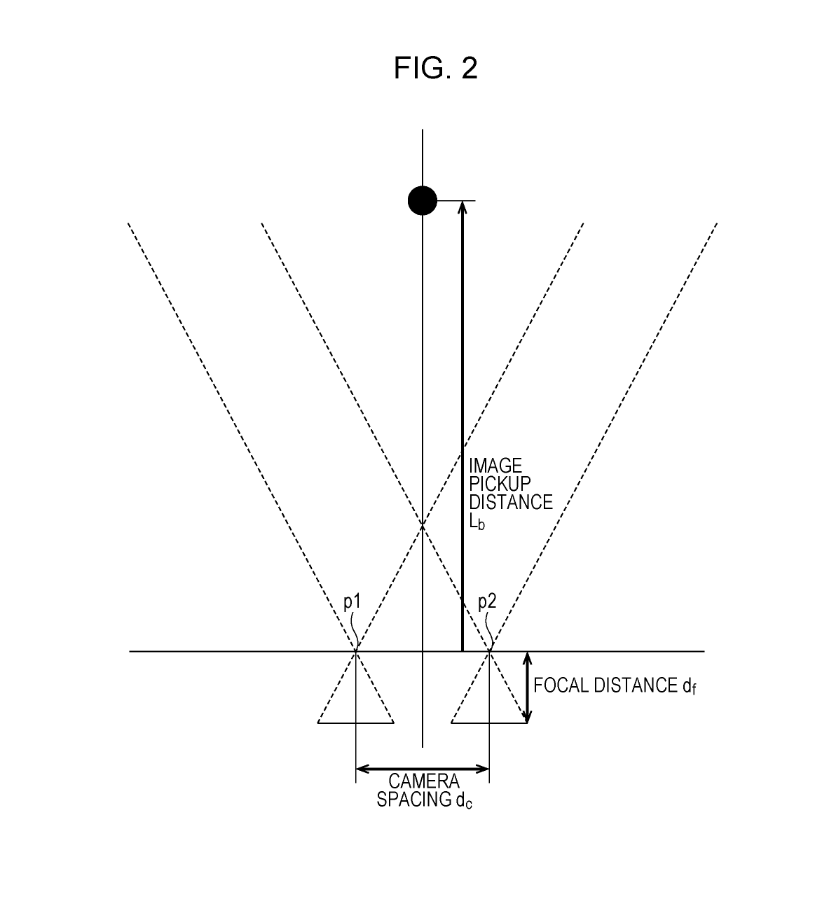

FIG. 2 is an illustration to explain the image-pickup condition information when the stereoscopic image is taken. The information representing the image pickup conditions contains a camera spacing d_{c}, a camera focal distance d_{f}, and a camera pixel pitch P_{c}. The camera spacing d_{c} implies, when images are taken from two viewing points, a distance between a position p1 at which one image is taken from one of the two viewing points and a position p2 at which the other image is taken from the other viewing point. In the case using two cameras, the camera spacing d_{c} implies a camera-to-camera distance. When the images are taken by sliding one camera in the horizontal direction, the camera spacing d_{c} implies a distance through which the camera is moved. The distance through which the camera is moved may be input from a sensor (not illustrated) or may be calculated from a natural feature variable in the taken image.

The camera focal distance d_{f} implies a distance between an image pickup element and a lens in the camera, and it is a fixed value in the case of a single focus lens. In the case of a zoom lens, because the focal distance changes depending on a zooming scale, the focal distance d_{f} is obtained from a sensor (not illustrated). The pixel pitch P_{c} is an index representing precision of a light receiving element of the camera, and it implies a distance between adjacent pixels. The camera pixel pitch can be calculated from the number of pixels and the size of the image pickup element, and it is a value specific to each image pickup element.

The display condition holding portion 24 in FIG. 1 sends the display condition information held therein to the image processing unit 30. The display condition information may be set in advance, or set with user input, or detected by a detector (not illustrated). Using the detector to detect the display condition information is preferable in making the present invention automatically applicable to various types of display devices.

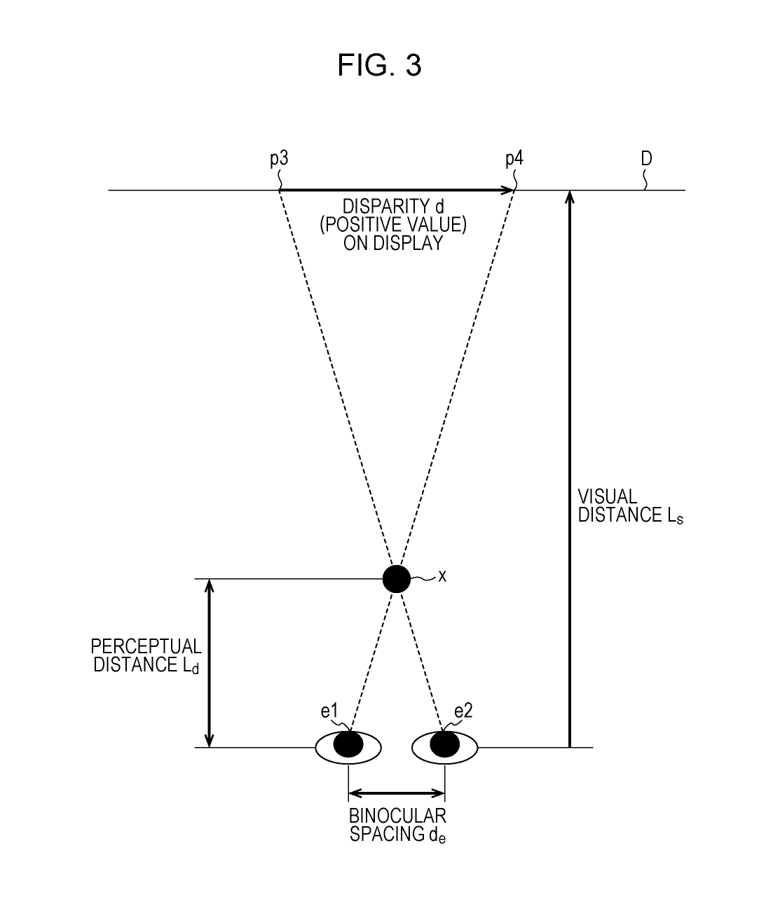

FIG. 3 is an illustration to explain the display conditions when the stereoscopic image is viewed. The information representing the display conditions contains a visual distance Lₛ, a binocular spacing dₛ, and a display pixel pitch P_{d}. The visual distance Lₛ implies a distance between a viewing person and a display plane D. The visual distance Lₛ can be set to a distance that is standard when the person views a display. For example, the visual distance Lₛ may be set to three times the height of the display, or may be set by recognizing a face of the viewing person with a camera (not illustrated) mounted on the display, and by determining the visual distance from the face size of the viewing person.

The binocular spacing dₑ implies a distance between a left eye e1 and a right eye e2 of the viewing person. The binocular spacing dₑ may be set to 50 mm that is a distance between a left eye and a right eye of an ordinary child, or to 65 mm that is an eye-to-eye distance of an ordinary adult. Alternately, the binocular spacing dₑ may be set by recognizing eyes of the viewing person with a camera (not illustrated) mounted on the display, and by measuring the length between the left eye and the right eye of the viewing person.

The display pixel pitch P_{d} implies a distance between adjacent pixels of the display. The display pixel pitch P_{d} can be calculated from the resolution and the display size, and it is a value specific to each display. It is to be noted that the image-pickup condition information and the display condition information are indicated in a unit representing length, e.g., mm.

The image processing unit 30 obtains information from the above-described information acquisition unit 20 and executes processing of the stereoscopic image. The image processing unit 30 is featured in correcting a distortion of a perceived position in the input stereoscopic image in accordance with the image-pickup condition information and the display condition information.

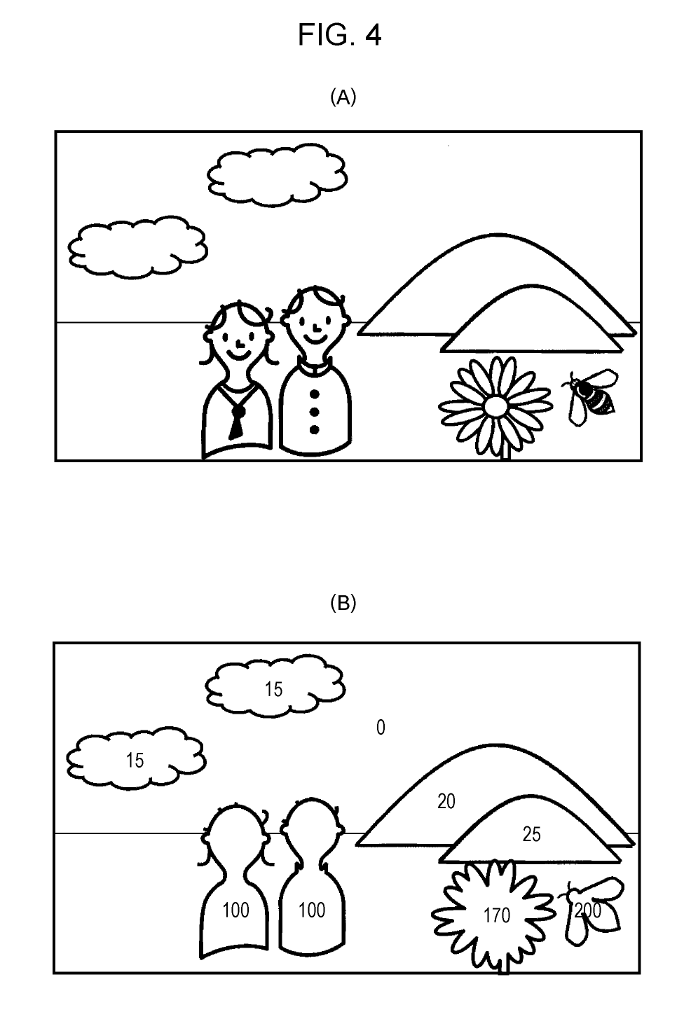

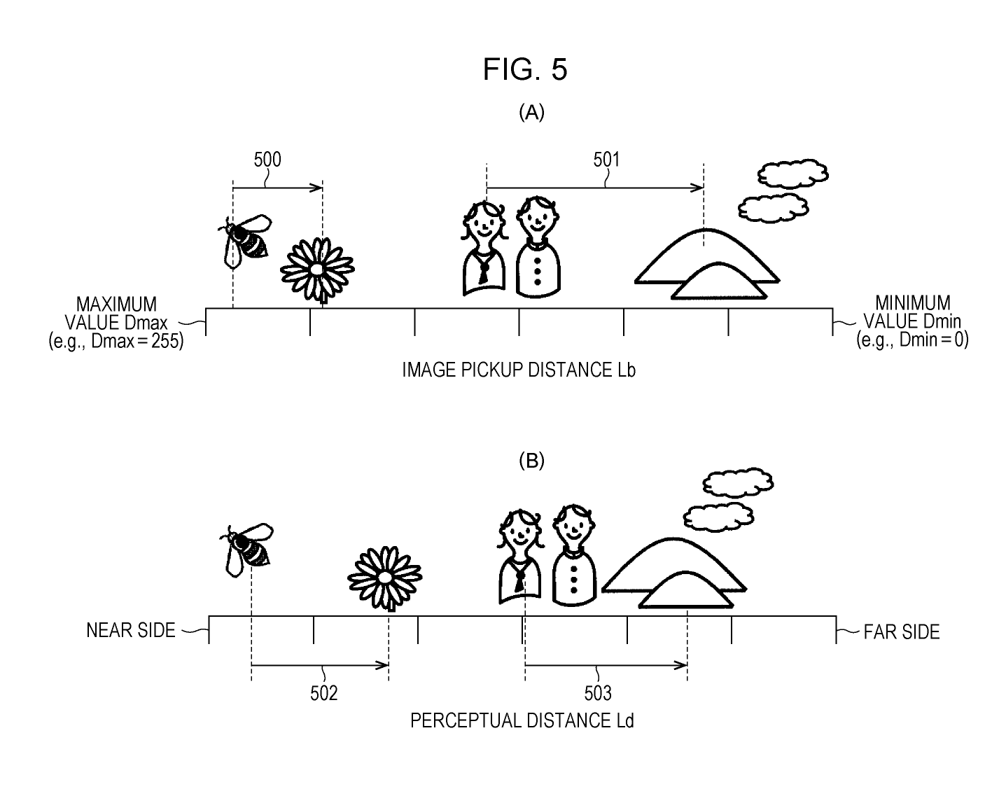

The distortion of the perceived position will be described in detail below with reference to FIGS. 4 and 5. FIG. 4 illustrates, of a left-eye adapted image and a right-eye adapted image constituting a stereoscopic image, the left-eye adapted image (FIG. 4(A)) and disparity information (FIG. 4(B)) corresponding to the left-eye adapted image. FIG. 5 illustrates an image pickup distance L_{b} (FIG. 5(A)) when the stereoscopic image of FIG. 4 is taken, and a perceptual distance L_{d} (FIG. 5(B)) when the stereoscopic image is viewed on a stereoscopic image display device.

In the stereoscopic image illustrated in FIG. 4, the left-eye adapted image is translated to the left through pixels of a disparity Hc such that a value of the disparity 0 corresponds to infinity. Stated in another way, an object having the disparity Hc is perceived at the disparity 0, i.e., on the display plane. Here, the image pickup distance L_{b} implies a distance along the length of a linear line interconnecting the object and the camera position. The perceptual distance L_{d} implies a distance along the length of a linear line interconnecting the position at which the object is perceived and the position of the viewing person.

As illustrated in FIG. 5, in the case of viewing the taken stereoscopic image as it is, due to a spatial distortion generated in taking and displaying the image, an object on the far side is viewed with a distance between the object and a background being compressed (from an object-to-object distance 501 to 503), and objects on the near side are viewed with a distance between the objects being enlarged (from an object-to-object distance 500 to 502), thus resulting in an unnatural stereoscopic image. Those compression and enlargement occur oppositely on both sides of the display plane. In view of the above point, disparity conversion, i.e., perceived position adjustment, is performed such that the image pickup distance L_{b} and the perceptual distance L_{d} are held in linear relation. After the perceived position adjustment, disparity correction is further performed for a region where a difference in disparity between the objects has been enlarged, such that the object is perceived with an appropriate thickness.

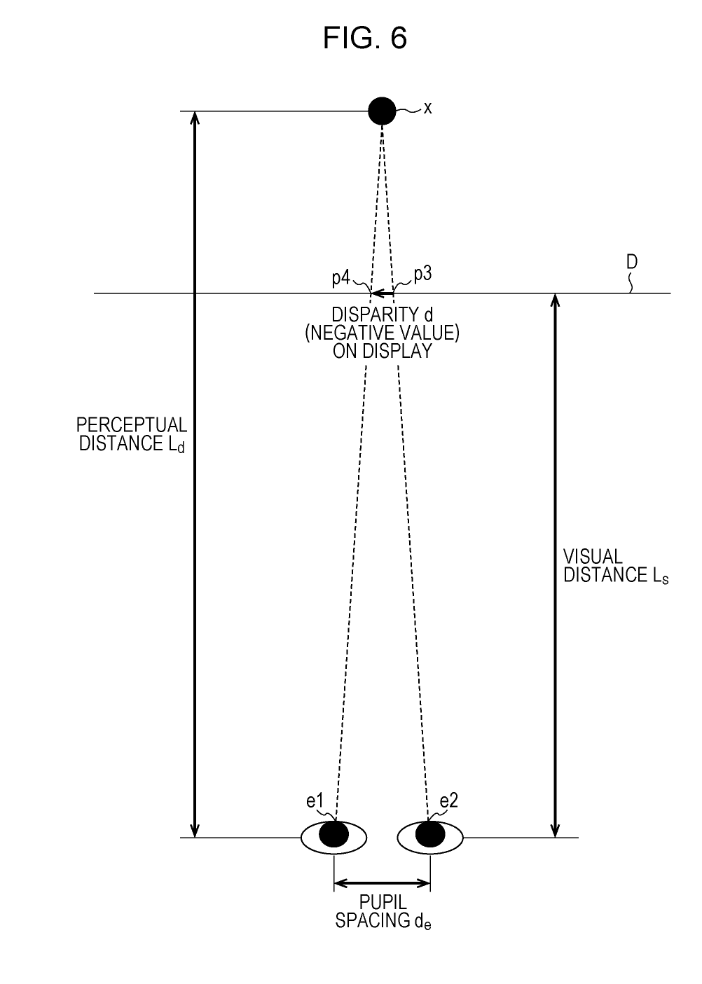

The distortion of the perceptual distance is now described in more detail. The perceptual distance L_{d} is calculated using the image-pickup condition information and the display condition information. As illustrated in FIG. 3, the perceptual distance L_{d} implies a distance from the viewing person to a point x at which a line interconnecting the left eye e1 of the viewing person and a point p4 in the left-eye adapted image on the display plane D intersects a line interconnecting the right eye e2 of the viewing person and a point p3 in the right-eye adapted image on the display plane D. The length of a line interconnecting the point p4 in the left-eye adapted image and the point p3 in the right-eye adapted image represents a disparity d. FIG. 3 illustrates an example in which the disparity has a positive value. The positive value of the disparity d indicates the case where the point p4 in the left-eye adapted image is positioned on the right side of the point p3 in the right-eye adapted image. When the disparity d has a negative value, the perceptual distance L_{d} is longer than the visual distance Lₛ and the stereoscopic image is perceived on the side farther than the display plane D, as illustrated in FIG. 6. When the disparity is 0, the perceptual distance L_{d} and the visual distance Lₛ are equal to each other, and the stereoscopic image is perceived on the display plane D.

By employing the information representing the image-pickup conditions and the display conditions described above, the perceptual distance L_{d}, i.e., the distance from the eyes of the viewing person to the stereoscopic image, is expressed by the following formula (1):

$$\begin{matrix}[ Math . 1 ] & \\ {L}_{d} = \frac{1}{\frac{1}{{L}_{s}} + \frac{{d}_{c}}{{d}_{e}} \cdot \frac{1}{{L}_{b}} - \frac{{H}_{c} {P}_{d}}{{d}_{e} {L}_{s}}} & ( 1 )\end{matrix}$$

Accordingly, the camera spacing d_{c} and the binocular spacing dₑ affect the relationship between the image pickup distance L_{b} and the perceptual distance L_{d}.

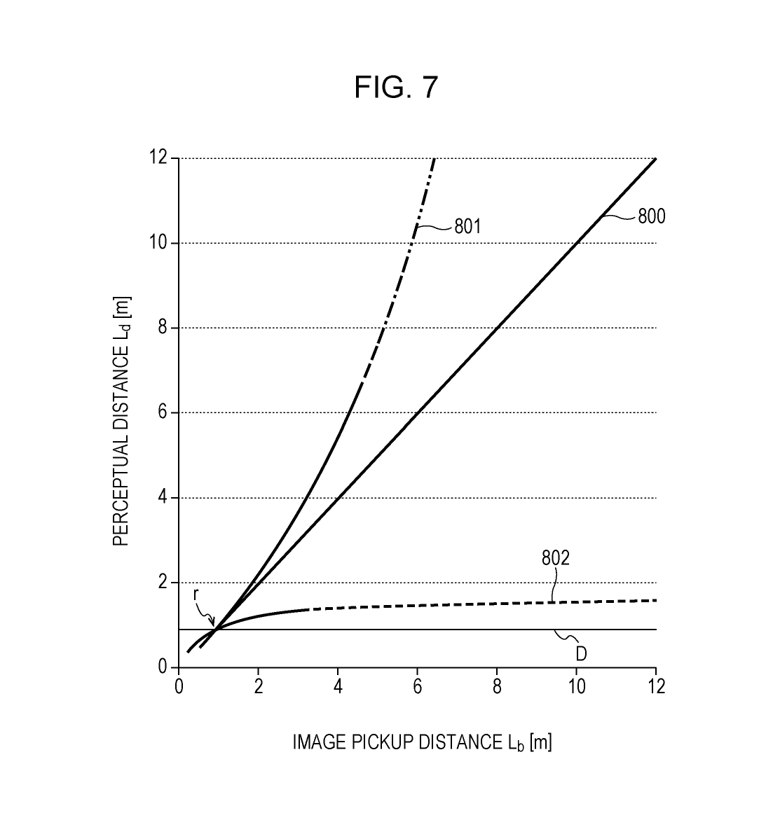

FIG. 7 is an illustration to explain the relationship between the image pickup distance L_{b} and the perceptual distance L_{d}. In FIG. 7, the horizontal axis indicates the image pickup distance L_{b} and the vertical axis indicates the perceptual distance L_{d}.

As illustrated in FIG. 7, when the camera spacing d_{c} and the binocular spacing dₑ of the image pickup conditions are the same, the image pickup distance L_{b} and the perceptual distance L_{d} are in linear relation. In FIG. 7, a line 800 represents that case where the image pickup distance L_{b} and the perceptual distance L_{d} are the same. However, when the camera spacing d_{c} and the binocular spacing dₑ are not the same, a spatial distortion generates in the displayed stereoscopic image. For example, the camera spacing d_{c} is wider than the binocular spacing dₑ, the so-called puppet theater effect occurs.

The puppet theater effect implies a phenomenon that the perceptual distance L_{d} perceived to be located on the side farther than the display plane D is enlarged relative to the image pickup distance L_{b}. On that occasion, the perceptual distance L_{d} on the side nearer than the display plane D is compressed. In other words, the spatial distortion occurs such that, in stereoscopic view, an object is perceived to be smaller than the actual size of the object. In FIG. 7, a line 801 represents such a case. Thus, in a region where the image pickup distance L_{b} is longer than that at a point r corresponding to the display plane D, the perceptual distance L_{d} is enlarged as the image pickup distance L_{b} increases. On the other hand, in a region where the image pickup distance L_{b} is shorter than that at the point r corresponding to the display plane D, the perceptual distance L_{d} is compressed as the image pickup distance L_{b} decreases.

When the camera spacing d_{c} is narrower than the binocular spacing dₑ, a spatial distortion called the cardboard effect occurs. The cardboard effect implies a phenomenon that the perceptual distance L_{d} perceived to be located on the side farther than the display plane D is compressed relative to the image pickup distance L_{b}. Thus, the perceptual distance L_{d} is compressed relative to the image pickup distance L_{b} with the cardboard effect. On that occasion, the perceptual distance L_{d} on the side nearer than the display plane D is enlarged. Stated in another way, in stereoscopic view, an object is perceived to be thinner than the actual thickness of the object, or a spatial distance between the background and the object is perceived to be relatively narrow. In FIG. 7, a line 802 represents such a case. Thus, in the region where the image pickup distance L_{b} is longer than that at the point r corresponding to the display plane D, the perceptual distance L_{d} is compressed on the side farther than the display plane D. On the other hand, in the region where the image pickup distance L_{b} is shorter than that at the point r corresponding to the display plane D, the perceptual distance is enlarged as the image pickup distance L_{b} decreases.

As seen from the above discussion, the image display device 1 can be configured so as to display a stereoscopic image free from the spatial distortion even when the camera spacing d_{c} and the binocular spacing dₑ are not the same, by correcting the disparity such that the image pickup distance L_{b} and the perceptual distance L_{d} come closer to a linear relation.

The image processing unit 30 includes a perceived position adjustment portion 32, an object structure correction portion 33, and an image generation portion 31. The perceived position adjustment portion 32 generates a disparity conversion table that is applied to disparity information, and sends the disparity conversion table to the object structure correction portion 33 along with the disparity information.

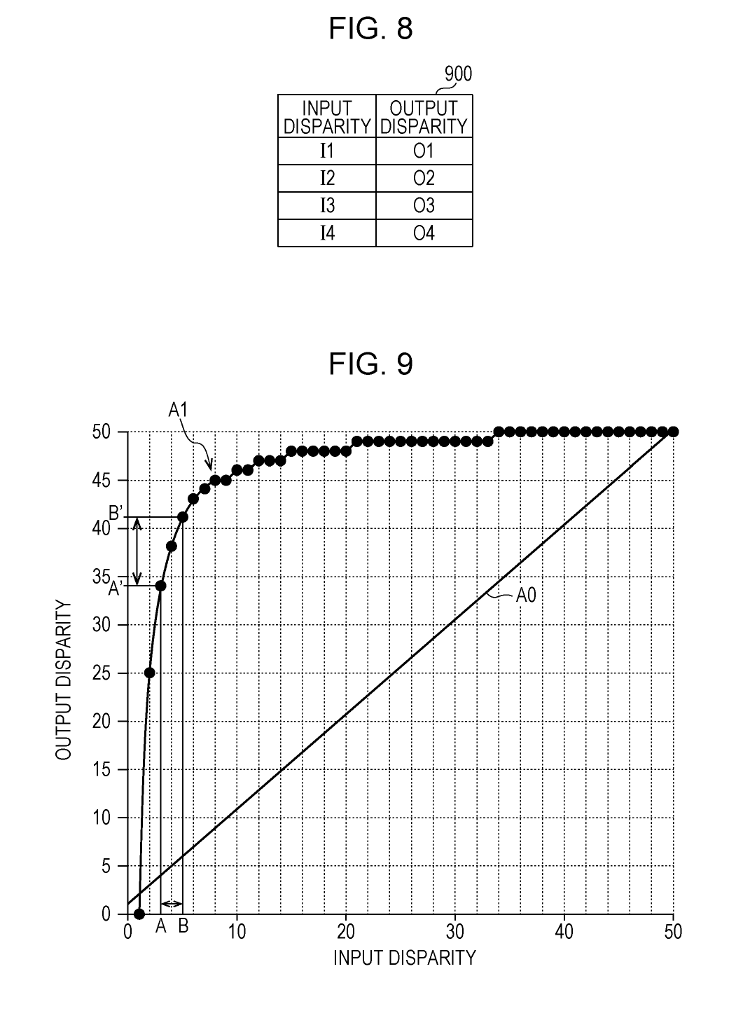

FIG. 8 illustrates the configuration of the disparity conversion table. The disparity conversion table 900 represents the relationship between an input disparity I and an output disparity O. The disparity conversion table 900 is featured in that the image pickup distance L_{b} calculated using the input disparity I and the perceptual distance L_{d} calculated using the output disparity O become equal to each other. The disparity conversion table is created by employing the following formula (2):

$$\begin{matrix}[ Math . 2 ] & \\ {Z}_{o} = \frac{{d}_{e}}{{P}_{d}} ( \frac{{L}_{s} {P}_{c}}{{d}_{c} {d}_{f}} {Z}_{i} - 1 ) & ( 2 )\end{matrix}$$

Zi denotes the input disparity, and Zo denotes the output disparity. The disparity conversion table storing the input disparity Zi and the output disparity Zo corresponding to the input disparity Zi is created by employing the formula (2). The disparity information making the image pickup distance L_{b} and the perceptual distance L_{d} held in linear relation can be generated by employing the disparity conversion table thus created.

FIG. 9 is graph plotting the relationship between the input disparity and the output disparity after the conversion using the disparity conversion table. In FIG. 9, the horizontal axis indicates the input disparity, and the vertical axis indicates the output disparity. If the disparity conversion process is not performed, the relationship between the input disparity and the output disparity is represented by a linear line A0. The relationship between the input disparity and the output disparity after the conversion using the disparity conversion table is represented by A1 that is nonlinearly mapped in accordance with the disparity conversion table. More specifically, at the image pickup distance L_{b} having a larger value, i.e., at a smaller disparity value, a distance in the depth direction toward the farther side, which has been compressed to a larger extent, is enlarged. On the other hand, at the image pickup distance L_{b} having a smaller value, i.e., at a larger disparity value, a distance in the depth direction toward the farther side, which has been enlarged to a larger extent, is compressed.

For example, a length between two arbitrary points (A, B) representing the input disparity is different from a length between two points (A′, B′) representing the output disparity that corresponds to the relevant input disparity. In other words, a change amount of the disparity is changed depending on the image pickup distance L_{b} so as to compress a distance in the depth direction at a position where the distance in the depth direction has been enlarged, and to enlarge a the distance in the depth direction at a position where the distance in the depth direction has been compressed, thereby executing the disparity conversion such that the relationship between the image pickup distance L_{b} and the perceptual distance L_{d} comes more closely linear. The perceived position adjustment portion 32 supplies the created disparity conversion table and the disparity information to the object structure correction portion 33.

In the above-described example of FIG. 9, the distance in the depth direction is compressed by increasing the disparity in the region where the image pickup distance L_{b} is long, i.e., where the disparity value is small, thus correcting the line 801 in FIG. 7 when the camera spacing d_{c} is wider than the binocular spacing dₑ. On the other hand, in the case of correcting the line 802 in FIG. 7 when the camera spacing d_{c} is narrower than the binocular spacing dₑ, it is required to conversely decrease the disparity and enlarge the distance in the depth direction in the region where the image pickup distance L_{b} is long, i.e., where the disparity value is small. Stated in another way, in the case of converting the disparity in a decreasing direction or in an increasing direction, the direction in conversion of the disparity is reversed between when the binocular spacing contained in the display condition information is larger than the camera spacing contained in the image-pickup condition information and when the binocular spacing is smaller than the camera spacing. As a result, the disparity conversion can be properly performed depending on the relationship between the camera spacing and the binocular spacing.

Furthermore, the image processing unit reverses the direction of conversion of the disparity, i.e., selectively sets one of the disparity decreasing direction and the disparity increasing direction, between when the disparity of the stereoscopic image output from the image processing unit is positive and when it is negative. In the case of viewing the taken stereoscopic image as it is, the compression and the enlargement of the image pickup distance L_{b} and the perceptual distance L_{d} occur reversely on both sides of the display plane. When the stereoscopic image is perceived on the side nearer than the display plane D, the disparity is positive, and when the stereoscopic image is perceived on the side farther than the display plane D, the disparity is negative. Accordingly, the direction of conversion of the disparity is reversed between when the disparity is positive and when the disparity is negative.

In accordance with the disparity conversion table and the disparity information both supplied from the perceived position adjustment portion 32, the object structure correction portion 33 generates disparity information in which the number of gradation scales of the disparity information is increased near a disparity edge after the application of the disparity conversion table. This implies that, because a disparity difference between objects is increased with the disparity conversion, the increased disparity difference is to be interpolated.

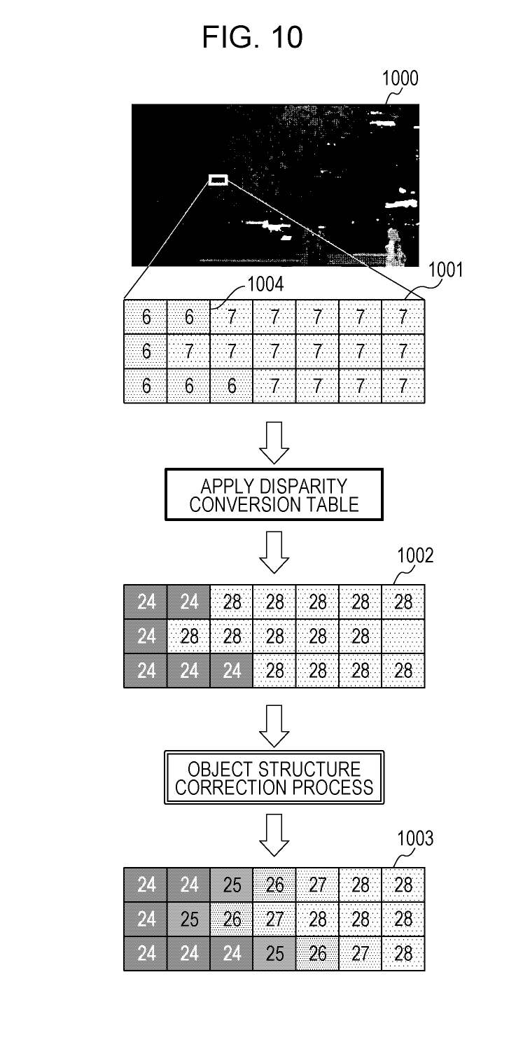

FIG. 10 illustrates an example in which the object structure correction portion is applied to disparity information 1000. In input disparity 1001, the difference between the adjacent disparities is 1. However, in output disparity 1002 after the application of the disparity conversion table, the difference between the adjacent disparities is 4 and the disparity difference between the objects is increased. This implies that a distortion specific to a stereoscopic space is increased four times. In order to correct such a distortion, the object structure correction portion 33 detects a disparity edge in the input disparity, i.e., a disparity change point 1004, and executes a gradation-scale number increasing process between the relevant disparity change point and a disparity change point that is detected next. In disparity information 1003 output from the object structure correction portion 33, the disparity information is interpolated such that the spatial distortion is corrected.

Details of processing executed in the object structure correction portion 33 will be described below.

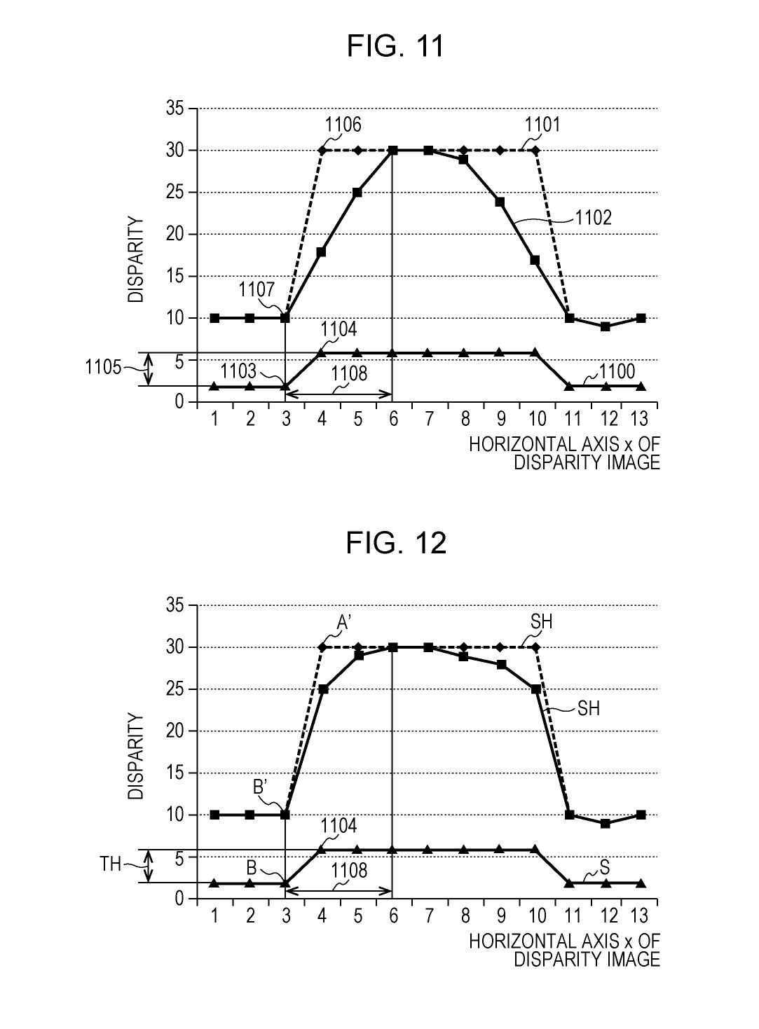

FIG. 11 illustrates the details of the processing executed in the object structure correction portion 33.

In FIG. 11, the horizontal axis indicates a position along a horizontal axis represented by the disparity information, and the vertical axis indicates the disparity.

First, a disparity change point 1004 is detected from disparity information 1100. The disparity change point 1104 implies a point where, in the disparity information 1100, the disparity of a target pixel (disparity change point 1104) is changed by a threshold 1105 or more in comparison with that of a preceding pixel 1103. A region between a pixel 1106 in disparity information 1101 obtained after the disparity conversion corresponding to the target pixel 1104 and a pixel 1107 in the disparity information 1101 obtained after the disparity conversion corresponding to the preceding pixel 1103 is interpolated over a width 1108. The interpolation in the example of FIG. 11 is preformed by adding one by one to a value of the pixel 1107 such that the disparity comes closer to the value of the pixel 1106, or by subtracting one by one from the value of the pixel 1106 such that the disparity comes closer to the value of the pixel 1107.

Alternatively, the interpolation may be performed with nonlinear approximation as illustrated in FIG. 12. In other words, the pixel interpolation method may be performed with linear approximation or curve approximation. In particular, it is preferable to analyze pixels near the target pixel and to perform interpolation along a line curved following a recess and a projection of the object for the reason that such a method enables the approximation to come even closer to the intrinsic shape of the object. The shape of the object can be estimated, for example, by determining how brightness of the surrounding pixels is changed. The disparity of other pixels other that at the disparity change point is converted to a value in accordance with the disparity conversion table such that the image pickup distance L_{b} and the perceptual distance L_{d} correspond to linearly.

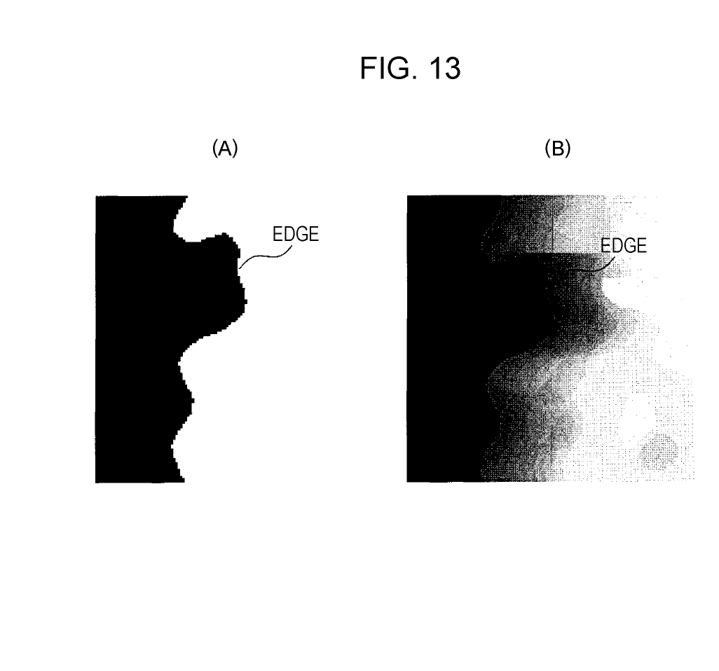

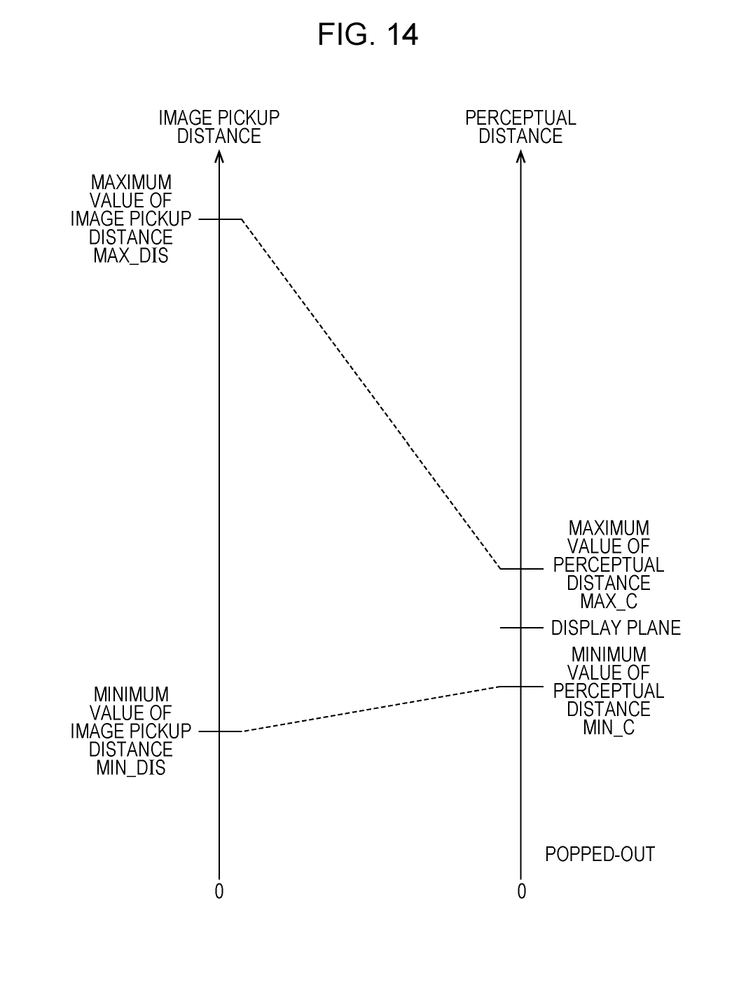

FIG. 13 illustrates the result of applying the object structure correction. Specifically, FIG. 13(A) represents an input disparity image, and FIG. 13(B) represents a disparity image after the object structure correction. In the disparity image after the object structure correction, the number of gradation scales is increased near a disparity edge and the object is more likely to be perceived a little round in comparison with the input disparity information. By executing the above-described processing, discontinuous portions in disparity appearing between the objects and between the object and the background can be interpolated, and the distortion specific to the stereoscopic space can be corrected. The object structure correction portion 33 supplies the disparity information after the correction to the image generation portion 31.

In accordance with the stereoscopic image supplied from the stereoscopic image acquisition portion 21 and the disparity information supplied from the object structure correction portion 33, the image generation portion 31 executes processing on, of the left-eye adapted image and the right-eye adapted image constituting the stereoscopic image, the left-eye adapted image. More specifically, pixels of the left-eye adapted image are moved in accordance with the disparity information supplied from the object structure correction portion 33. After moving the pixels, pixels which have not been made correspondent to pixels of the output image are interpolated from nearby pixels.

Here, to take the intrinsic disparity between the left-eye adapted image and the right-eye adapted image into consideration, the value of the disparity information supplied from the disparity information acquisition portion 22 is subtracted from the value of the disparity information supplied from the object structure correction portion 33. A stereoscopic image is generated using the left-eye adapted image after the conversion and the input right-eye adapted image. As a result, the stereoscopic image can be generated in which the distortion specific to the stereoscopic view is corrected. The generated stereoscopic image made up of the left-eye adapted image and the right-eye adapted image is supplied to the display unit 40. A similar operating effect can also be obtained by executing the processing while respective amounts through which pixels are to be moved are given in the disparity conversion table.

With the image display device according to the present invention, as described above, since, in accordance with the image-pickup condition information and the display condition information read out from the storage unit, the disparity of the stereoscopic image corresponding to the relevant image-pickup condition information is corrected, a more natural stereoscopic image can be displayed even when the camera spacing d_{c} and the binocular spacing dₑ are not the same. With the image display device, particularly, since discontinuity in disparity between objects can be interpolated, the distortion of the stereoscopic space, such as the cardboard effect, can be corrected.

While, in this embodiment, the disparity conversion is performed such that the image pickup distance L_{b} and the perceptual distance L_{d} are held in linear relation, the disparity conversion may be performed by setting a main object, and by executing the conversion such that the disparity of the main object becomes a value close to 0. Such a method is advantageous in that an object having been selected as the main object is displayed at a position near the display plane, the position being suitable for stereoscopic view. The main object is designated or detected by a predetermined method. For example, a user may designate the main object with an input device (not illustrated). As an alternative, a face of an object may be recognized through image processing, and the recognized face may be detected as the main object.

While, in this embodiment, the disparity information is generated by the disparity information acquisition portion 22, the disparity information may be read out from a recording medium. In that case, it is required that not only a stereoscopic image, but also the disparity information and the image-pickup condition information both corresponding to the stereoscopic image are recorded on the recording medium. Such a modification eliminates the necessity of complicated calculation executed in the disparity information acquisition portion and contributes to cutting a processing time.

While, in this embodiment, the stereoscopic image and the image-pickup condition information are obtained from the storage unit 10, they may be obtained from an image pickup unit. The image pickup unit is constituted by at least two cameras that take a left-eye adapted image and a right-eye adapted image, respectively. Each of the cameras includes an image pickup lens and an image pickup element, such as a CCD. An image pickup control unit controls, for example, a focus position and a zoom factor of the image pickup lens, and driving of a shutter, etc. Furthermore, the at least two cameras are disposed at a predetermined spacing, and respective optical axes of the cameras are arranged parallel to each other. In such a case, image-pickup condition information related to one of the at least two cameras is obtained as the image-pickup condition information.

While, in this embodiment, the stereoscopic image is output from the image generation portion 31 to the display unit 40, the stereoscopic image may be output to a recording device. The recording device records a stereoscopic image constituted by a left image and a right image, which are supplied from the image generation portion 31.

Moreover, the display unit 40 in this embodiment may be a spectacle type stereoscopic display device displaying an image that is viewed by a person putting on spectacles, or a naked-eye type stereoscopic display device allowing a person to view a stereoscopic image with the naked eyes. In the case of the spectacle type stereoscopic display device, the stereoscopic image may be displayed by a time division method that displays the stereoscopic image by alternately switching over the left-eye adapted image and the right-eye adapted image, or a polarization method that displays the stereoscopic image by superimposing both the images with polarization directions being different from each other. In the case of the naked-eye type stereoscopic display device, the stereoscopic image may be displayed by a parallax barrier method of alternately arranging the left-eye adapted image and the right-eye adapted image on the rear side of the so-called parallax barrier having slit-like openings, or a lenticular method of arranging substantially semi-cylindrical lenses to spatially separate the left-eye adapted image and the right-eye adapted image.

### Second Embodiment

A second embodiment employs a perceived position correction method different from that used in the first embodiment. It is to be noted that components having similar functions to those in the first embodiment described above are denoted by the same reference signs, and duplicate description of those components is omitted unless especially needed.

Although the second embodiment is practiced with the same configuration as that in the first embodiment illustrated in FIG. 1, the perceived position adjustment portion 32 in the image processing unit 30 operates in a different manner from that in the first embodiment, and it executes a process of setting a disparity range of the stereoscopic image after the disparity conversion within a predetermined range. More specifically, the perceived position adjustment portion 32 generates a stereoscopic image, which is contained in a range allowing the viewing person to see the stereoscopic image, corresponding to a stereoscopic image display device that displays the stereoscopic image.

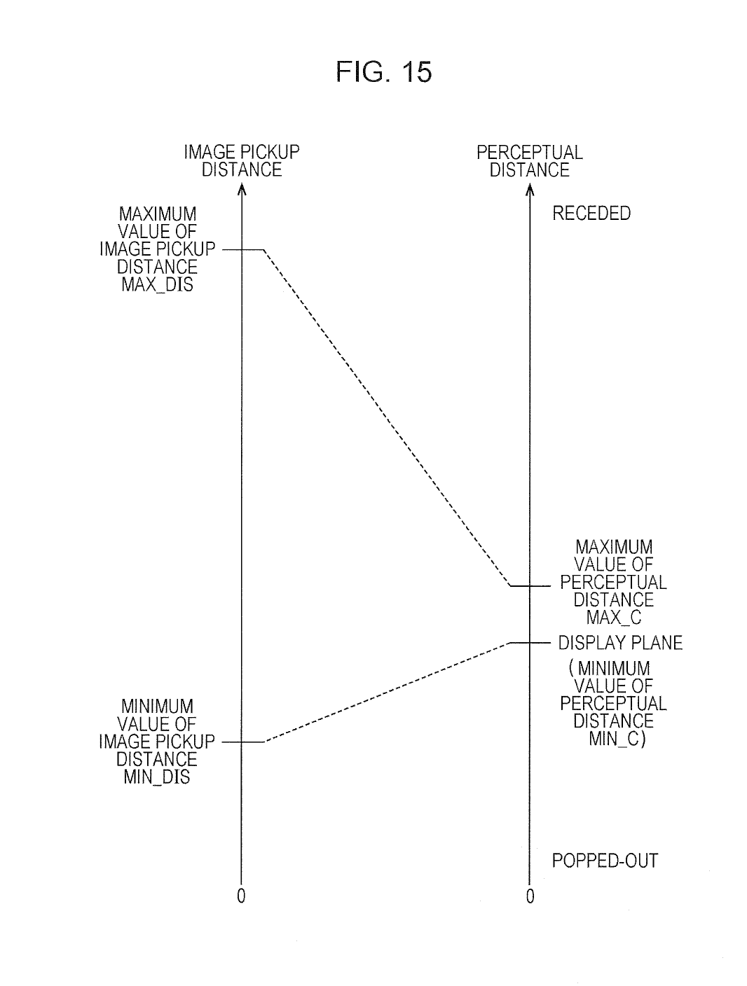

The perceived position adjustment portion 32 creates the disparity conversion table that is applied to the disparity information, and sends the created disparity conversion table to the object structure correction portion 33 along with the disparity information. By employing that disparity conversion table, it is possible to not only make the relationship between the image pickup distance L_{b} and the perceptual distance L_{d} come closer to be linear, but also to provide the disparity information that is set in the range allowing the viewing person to see the stereoscopic image, as illustrated in FIG. 14. A method of creating the disparity conversion table is described below.

By employing the image pickup condition information, a maximum value and a minimum value of the image pickup distance L_{b} can be calculated from a maximum value MAX_DEP and a minimum value MIN_DEP of the disparity in the disparity information. To obviate the influence of noise caused by a failure in calculation of the disparity, the maximum value and the minimum value of the disparity in the disparity information is preferably calculated from disparities occupying a region having a certain area in the disparity information, for example, a region corresponding to 1% of all pixels. From the maximum value MAX_DEP and the minimum value MIN_DEP of the disparity in the disparity information, a maximum value MAX_DIS and a minimum value MIN_DIS of the image pickup distance L_{b} are calculated using the following formula (3) and (4), respectively.

$$\begin{matrix}[ Math . 3 ] & \\ MAX\_DIS = \frac{{d}_{f} {d}_{c}}{{P}_{d} MIN\_DEP} & ( 3 ) \\ [ Math . 4 ] & \\ MIN\_DIS = \frac{{d}_{f} {d}_{c}}{{P}_{d} MAX\_DEP} & ( 4 )\end{matrix}$$

Next, a maximum value MAX_C and a minimum value MIN_C of the perceptual distance L_{d} are calculated using the display condition information and the disparity on the display. A minimum value MIN_E and a maximum value MAX_E of the disparity on the display may be given, for example, as values that are indicated in 3DC Safety Guidelines published from the 3D Consortium, or as values that are input by the user through an input device (not illustrated). On that occasion, the maximum value MAX_C and the minimum value MIN_C are each represented in units of pixel. When MAX_C is a positive value and MIN_C is a negative value, the object is perceived in a popped-out state and a receded state, respectively, in the depth direction.

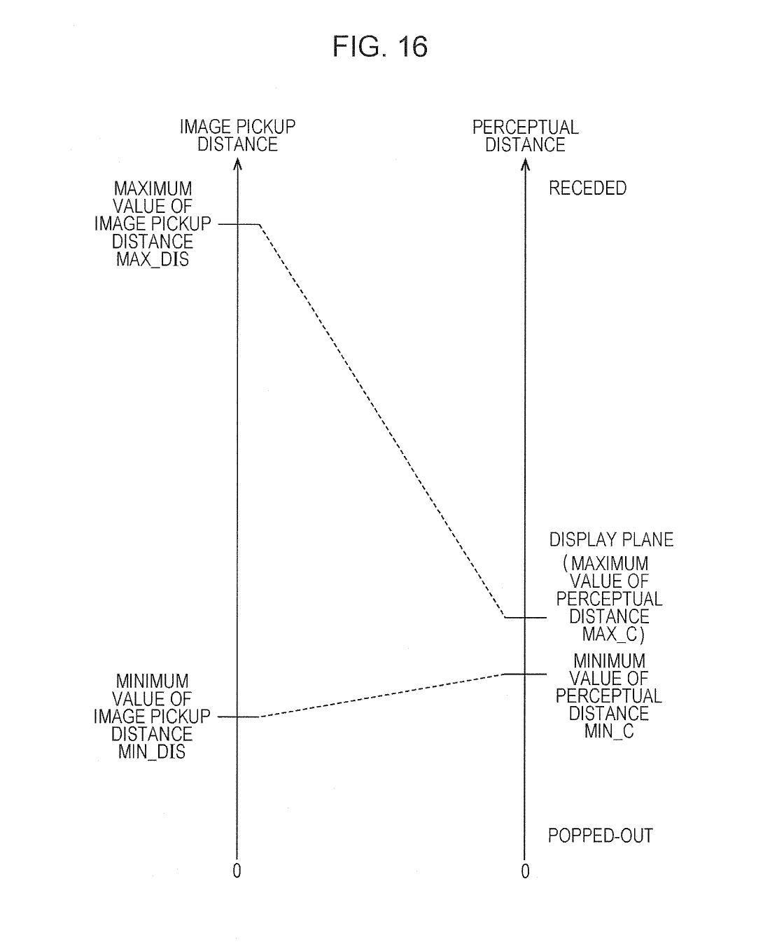

When a photographed scene is a long-distance view, the photographed object is perceived in a state receded to the farther side in the depth direction by setting the maximum value MAX_E of the perceptual distance L_{d} to a value near 0, as illustrated in FIG. 15. Furthermore, when a photographed scene is taken in a macro mode, the photographed object is perceived in a state popped out to the nearer side in the depth direction by setting the minimum value MIN_E of the perceptual distance L_{d} to a value near 0, as illustrated in FIG. 16. Such a photographed scene may be determined by analyzing the disparity information, or may be read out through an input device (not illustrated).

From the minimum value MIN_E and the maximum value MAX_E of the disparity on the display, the maximum value MAX_C and the minimum value MIN_C of the perceptual distance L_{d} when the scene is displayed are calculated using the following formula (5) and (6), respectively.

$$\begin{matrix}[ Math . 5 ] & \\ MAX\_C = \frac{{d}_{e} {L}_{sc}}{{d}_{e} + MIN\_DIS \times {P}_{d}} & ( 5 ) \\ [ Math . 6 ] & \\ MIN\_C = \frac{{d}_{e} {L}_{sc}}{{d}_{e} + MAX\_DIS \times {P}_{d}} & ( 6 )\end{matrix}$$

The disparity is then converted such that the calculated image pickup distance L_{b} and perceptual distance L_{d} are matched with each other. Given that the disparity in the input disparity information is Zi and the disparity in the output disparity information is Zo, the disparity conversion is expressed by the following formulae (7), (8) and (9).

$$\begin{matrix}[ Math . 7 ] & \\ {Z}_{o} = ( \frac{{d}_{e} {L}_{s}}{{L}_{o}} - {d}_{e} ) {P}_{d} & ( 7 ) \\ [ Math . 8 ] & \\ {L}_{o} = \frac{( MAX\_DIS - MIN\_DIS )}{( MAX\_C - MIN\_C )} ( {L}_{i} - MIN\_C ) & ( 8 ) \\ [ Math . 9 ] & \\ {L}_{i} = \frac{{d}_{f} {d}_{c}}{{P}_{d} {Z}_{i}} & ( 9 )\end{matrix}$$

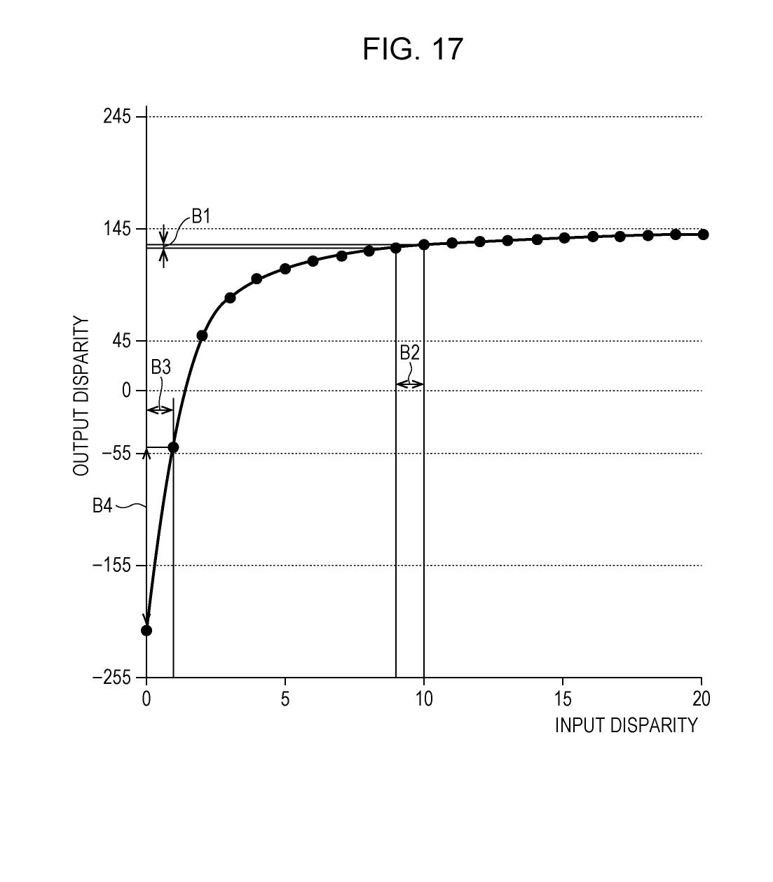

The disparity conversion table storing the input disparity Zi and the output disparity Zo corresponding to the former is created by employing the above disparity conversion formulae. Through the disparity conversion described above, the relationship between the image pickup distance L_{b} and the perceptual distance L_{d} can be made closer to be linear, and the disparity information can be generated in the range allowing the viewing person to see the stereoscopic image. FIG. 17 represents the relationship between the input disparity and the output disparity after the conversion in accordance with the disparity conversion table.

For the output disparity having a larger negative value, i.e., for a disparity causing an object to be perceived on the farther side than the display plane in a direction receding rearward, a distance having been compressed in the depth direction is enlarged to a larger extent. On the other hand, for the output disparity having a larger positive value, i.e., for a disparity causing an object to be perceived on the nearer side than the display plane in a direction popping out forward, a distance having been enlarged in the depth direction is compressed to a larger extent. Comparing a difference B2 between two arbitrary points in the input disparity with a difference B1 between two arbitrary points in the output disparity, B1<B2 holds and a distance in the depth direction is compressed. Comparing a difference B3 between two arbitrary points in the input disparity with a difference B4 between two arbitrary points in the output disparity, B4>B3 holds and a distance in the depth direction is enlarged. Thus, since a change amount of the disparity is changed depending on the image pickup distance L_{b} such that, for a position where a distance in the depth direction is enlarged, the distance is compressed, and for a position where a distance in the depth direction is compressed, the distance is enlarged, the relationship between the image pickup distance L_{b} and the perceptual distance L_{d} is converted to come closer to be linear.

As described above, according to this embodiment, the disparity information set in the range allowing the viewing person to see the stereoscopic image can be generated in conformity with the image display device that displays the stereoscopic image.

### Third Embodiment

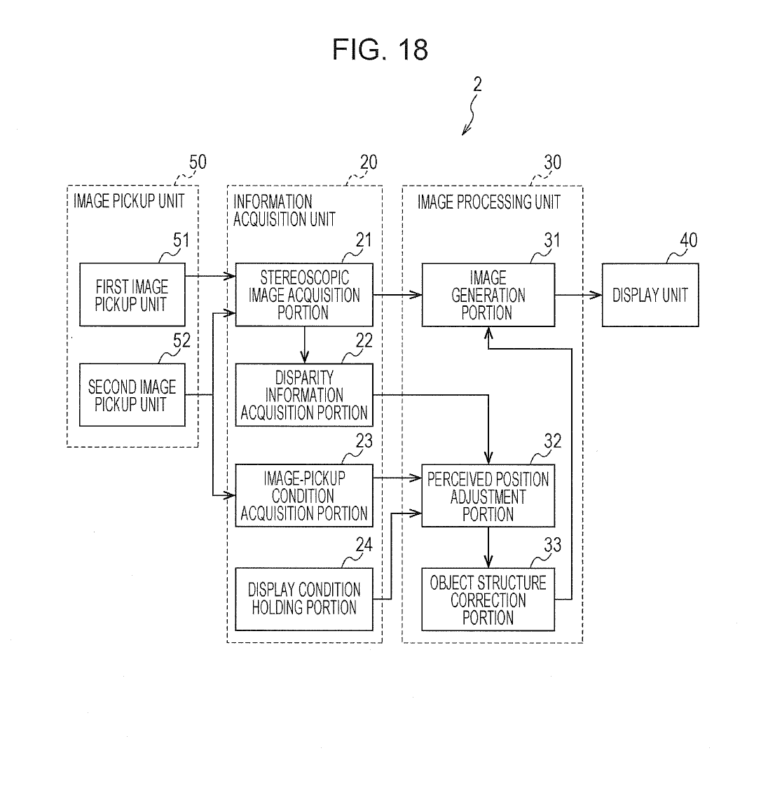

FIG. 18 is a block diagram illustrating an image pickup device, according to a third embodiment, which includes the image processing device according to the present invention. In FIG. 18, components having similar configurations to those in FIG. 1 are denoted by the same reference signs. Duplicate description of those components is omitted unless especially needed.

The configuration of an image pickup device 2 illustrated in FIG. 18 is mainly different from that illustrated in FIG. 1 in comprising an image pickup unit 50, which includes a first image pickup unit 51 and a second image pickup unit 52, instead of the storage unit 10. The image pickup device illustrated in FIG. 18 can generate a stereoscopic image in which the spatial distortion specific to the stereoscopic image is corrected, irrespective of a method of taking the stereoscopic image.

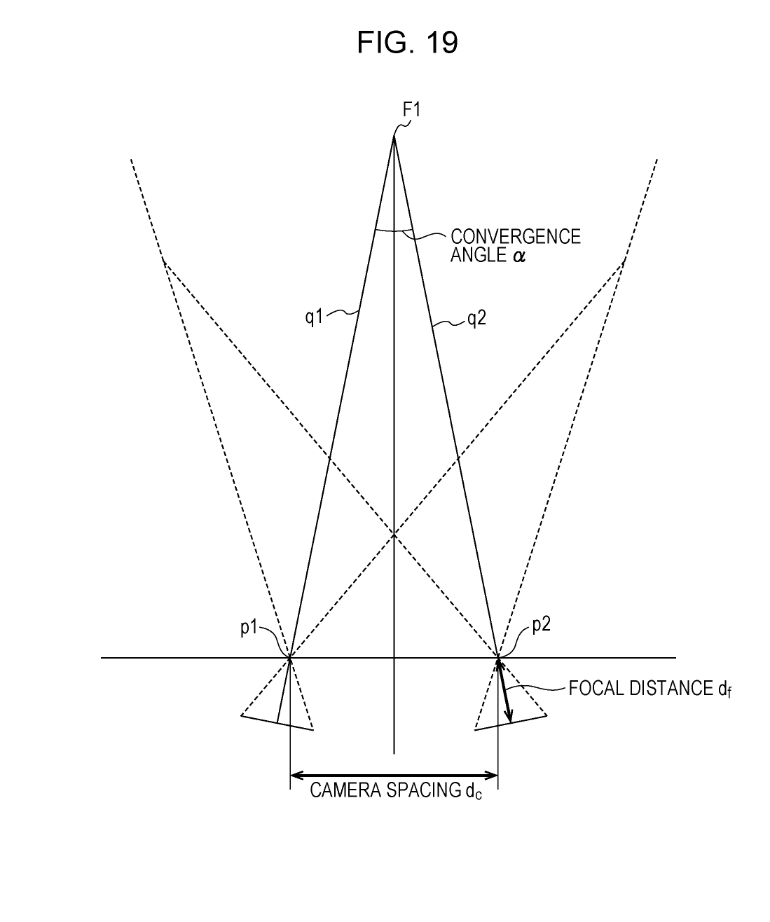

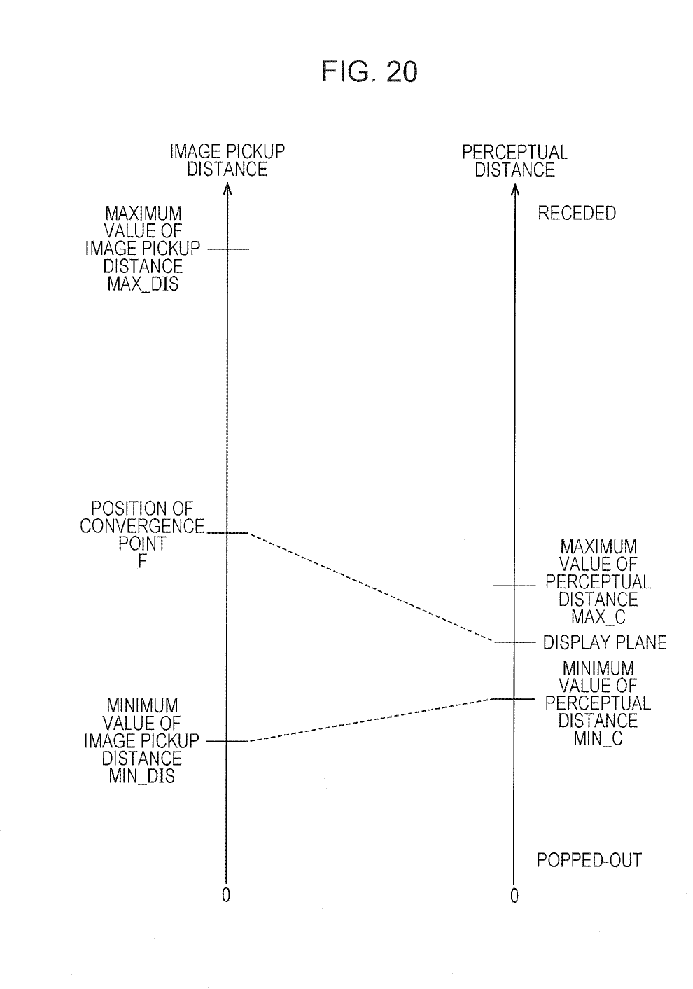

In more detail, the first image pickup unit 51 and the second image pickup unit 52 are arranged at positions spaced from each other through a predetermined distance. In synchronism with the second image pickup unit 52, the first image pickup unit 51 takes an image at the same time as the second image pickup unit 52 under the same image pickup condition as that for the second image pickup unit 52. The first image pickup unit 51 supplies resulting image data, as image data for a left eye, to the stereoscopic image acquisition portion 21. Furthermore, the first image pickup unit 51 supplies the camera spacing d_{c}, a convergence angle α, the camera pixel pitch P_{c}, and the camera focal distance d_{f}, as the image pickup condition information, to the stereoscopic image acquisition portion. As illustrated in FIG. 19, the convergence angle α for the first image pickup unit and the second image pickup unit implies an angle formed by an optical axis q1 of the first image pickup unit and an optical axis q2 of the second image pickup unit. A point F1 at which the optical axis q1 and the optical axis q2 intersect is a convergence point.

The perceived position adjustment portion 32 creates the disparity conversion table such that, as illustrated in FIG. 20, an object on the convergence angle is displayed on the display surface. To that end, the position of the convergence point is calculated from the convergence angle for the image pickup units by employing the following formula (10):

$$F = \frac{{d}_{c}}{2 cos ( \frac{α}{2} )} \qquad ( 10 )$$

The disparity conversion is executed such that the convergence point F1 is perceived on the display plane, i.e., at the same position as that of the visual distance Lₛ. In other words, the image processing unit 30 executes a process of setting the disparity of the object at a distance to the convergence point, which distance can be calculated from the image pickup condition information of the image pickup unit, to become close to 0. More specifically, a value of MAX_DIS is converted to F, and a value of MAX_C is converted to the visual distance Lₛ.

In accordance with the stereoscopic image supplied from the stereoscopic image acquisition portion 21 and the disparity information supplied from the object structure correction portion 33, the image generation portion 31 executes processing on, of the left-eye adapted image and the right-eye adapted image constituting the stereoscopic image, the left-eye adapted image.

In more detail, pixels of the left-eye adapted image are moved in accordance with the disparity information supplied from the object structure correction portion. After moving the pixels, pixels which have not been made correspondent to pixels of the output image are interpolated from nearby pixels. The stereoscopic image is generated by employing the generated left-eye adapted image and the input left-eye adapted image. As a result, the object present at the convergence point is displayed on the display plane, and the stereoscopic image can be generated in which the distortion specific to the stereoscopic view has been corrected. The stereoscopic image constituted by the left-eye adapted image after the disparity conversion process and the input left-eye adapted image is supplied to the display unit 40.

As described above, even for the stereoscopic image read out from the image pickup units having the convergence angle, the image pickup device 2 can display the object, which is positioned at the convergence point, at the visual distance Lₛ, i.e., on the display plane, in accordance with the image pickup condition information and the display condition information. Furthermore, even when the camera spacing d_{c} and the binocular spacing dₑ are not the same, the disparity of the stereoscopic image corresponding to the relevant image pickup condition is corrected, whereby a more natural stereoscopic image can be displayed.

### Fourth Embodiment

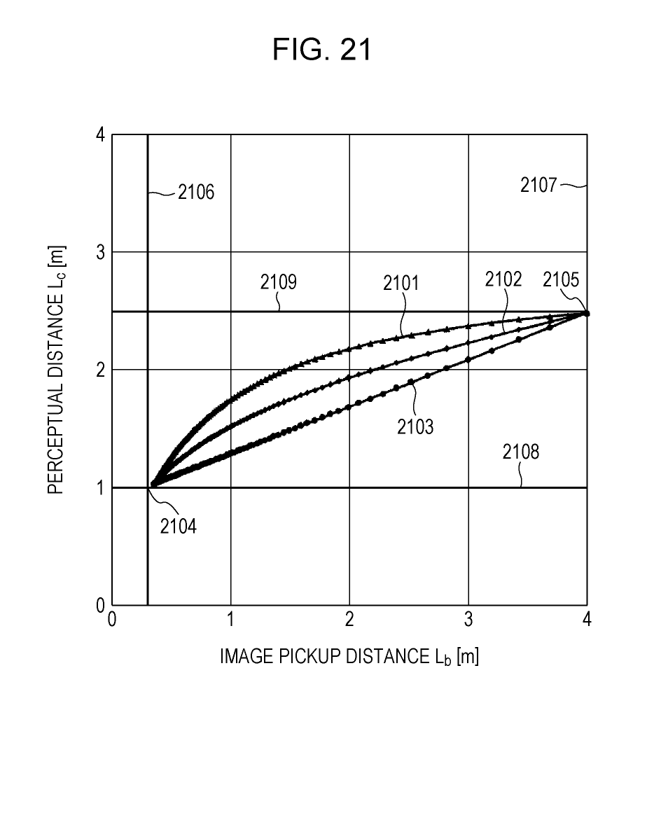

While an image perceived with a stereoscopic feel can be obtained by converting the disparity through the image processing described above in the first embodiment, a sufficient stereoscopic effect cannot be obtained depending on the position of the object when the disparity conversion is executed within the range between a maximum disparity and a minimum disparity of the taken stereoscopic image. Even in such a case, a satisfactory stereoscopic feel can be provided by executing the disparity conversion as illustrated in FIG. 21.

A curve 2101 in FIG. 21 represents the relationship between an image pickup position of an object in a photographed image and a position at which the object is perceived when displayed in stereoscopic view. Such a curve is called here a perceptual curve 2101. A line 2103 in FIG. 21 represents a linear line interconnecting an intersect point 2104 of a minimum image pickup distance 2106 and a minimum perceptual distance 2108 of the photographed image and an intersect point 2105 of a maximum image pickup distance 2107 and a maximum perceptual distance 2109.

In this embodiment, a disparity conversion method is described below using the perceptual distance and the image pickup distance. As described in detail in the first embodiment, the perceptual distance and the image pickup distance can be calculated from the disparity value, the image pickup condition, and the display condition. The relationship between the image pickup distance and the perceptual distance can be changed by executing the disparity conversion on the stereoscopic image.

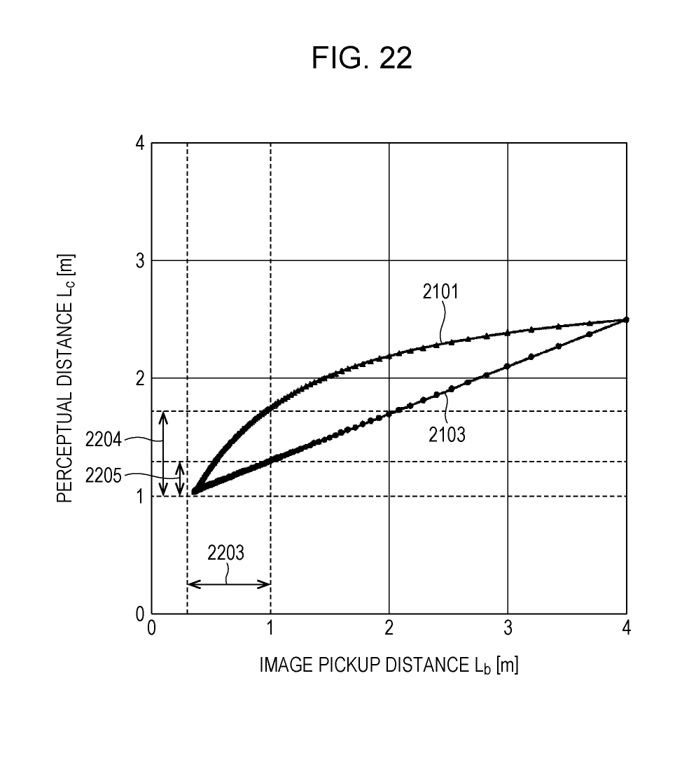

While, in the first embodiment, the spatial distortion is corrected for the entire photographed scene, the spatial distortion is corrected in the fourth embodiment such that the perceptual curve is positioned between the perceptual curve 2101 and the line 2103 in FIG. 21. For example, in the case of an object having a large disparity value, when the perceptual curve is corrected as per indicated by 2103 in FIG. 22, the disparity value assigned to the relevant object has a smaller width. In other words, the perceived stereoscopic feel is enhanced because of an increase in disparity difference between the background having a smaller disparity value and the foreground having a larger disparity value increases. However, a thickness of the object is reduced in some cases.

That point is described in more detail below with reference to FIG. 22. It is here assumed that 2203 denotes the thickness of the object, 2204 denotes the thickness of the object perceived in the case of seeing the photographed image in stereoscopic view, and 2205 denotes the thickness of the object perceived in the case of seeing the stereoscopic image in stereoscopic view after the correction. As apparent from FIG. 22, the thickness 2205 of the object perceived in the case of seeing the stereoscopic image in stereoscopic view after the correction is smaller than the thickness 2204 of the object perceived in the case of seeing the photographed image in stereoscopic view. Thus, when a main object is present within the image pickup distance corresponding to the thickness 2203, the main object cannot be perceived with a satisfactory stereoscopic feel. In view of the above point, the correction is performed as represented by a line 2102 in FIG. 21 such that the distortion in relationship between the object and the background is corrected while the thickness of the object is held satisfactorily, thus providing an image with the stereoscopic feel.

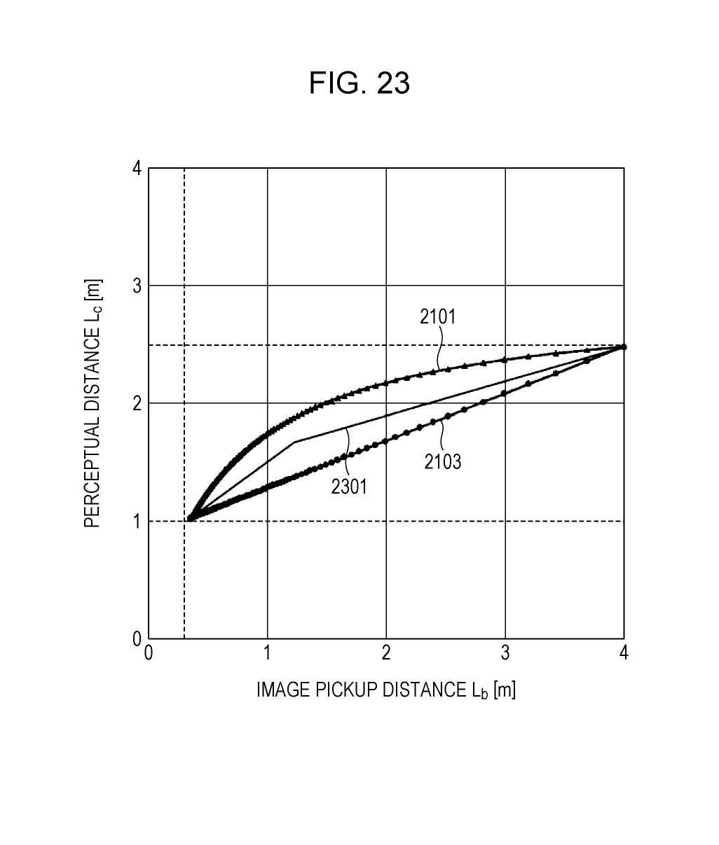

The line 2102 can be expressed by a linear line, a curved line, or a combination of linear and curved lines, which are each plotted within an area between the perceptual curve 2101 and the line 2013. The line 2102 may be expressed, for example, by two linear lines as denoted by a line 2301 in FIG. 23. Furthermore, it is preferable to define a characteristic of the disparity conversion with a weighed average of the perceptual curve 2101 and the line 2103 because the stereoscopic feel can be changed by the user adjusting weighing parameters from the outside.

The line 2102 in FIG. 21 represents an example in which respective weights applied to the perceptual curve 2101 and the line 2103 are set equal to each other. This implies that when the disparity conversion is executed as expressed by the line 2102, the object is perceived at a midpoint between an object position perceived when the photographed image is displayed in stereoscopic view without executing the disparity conversion and an object position perceived when the disparity conversion is executed as denoted by the line 2103. In other words, when the weight applied to the perceptual curve 2101 is set to be larger, the disparity of an object near the background is compressed, and the disparity in the foreground is enlarged. Thus, the perceived stereoscopic feel of the image after the disparity conversion comes closer to that of the original image in which the spatial distortion, including the cardboard effect and the puppet theater effect, occurs.

When the weight applied to the line 2103 is set to be relatively large, the disparity of an object near the background is enlarged, and the disparity of an object in the foreground is compressed. Thus, the spatial distortion is corrected, and the stereoscopic feel comes closer to that perceived with the actual space. With the characteristic calculated using the weighed average, therefore, the user can change the stereoscopic feel of the photographed stereoscopic image in such a way as making it come closer to that of the actual space, or as intentionally distorting a photographed space to emphasize the stereoscopic feel for the foreground.

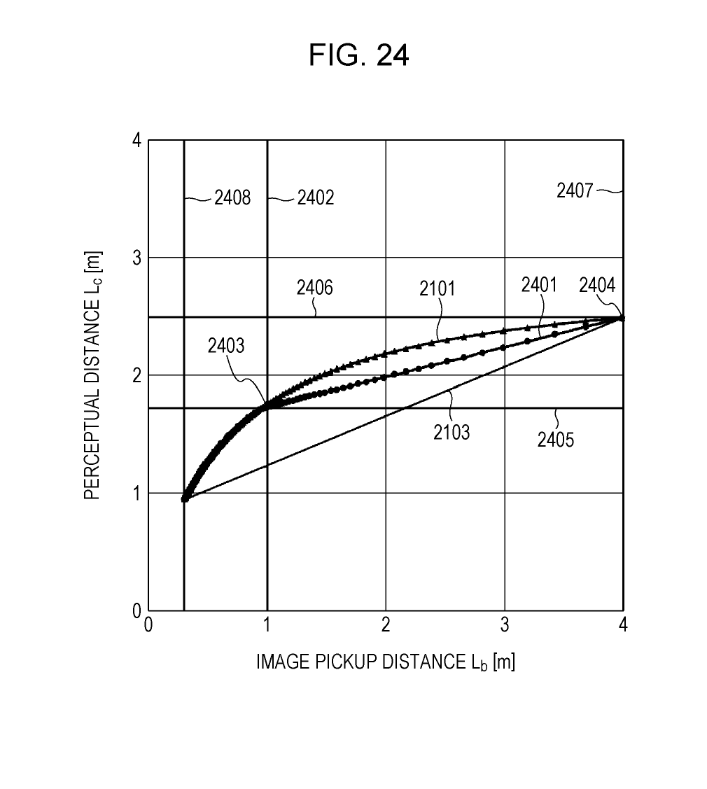

In particular, when the position of a main object is specified, it is preferable to execute the disparity conversion process on an object that is present on the rear side of a main object 2402, i.e., on an object having a smaller disparity than that of the main object 2402, as denoted by a line 2401 in FIG. 24.

A disparity value of the main object can be calculated from a disparity histogram. For instance, it is possible to divide an image into a plurality of regions, and to estimate a disparity value of the object from the most frequency value of the disparity among the regions. The disparity value is held without correction for a range between the estimated disparity value of the main object and a maximum disparity value in the photographed scene, while the disparity value is corrected to reduce the spatial distortion for a range between the estimated disparity value of the main object and a minimum disparity value in the photographed scene. On that occasion, because the estimated disparity value of the object is a typical disparity value of the object, processing is preferably executed by setting, as a boundary, a disparity value smaller than the estimated disparity value. In other words, the disparity value is corrected in a manner of changing the correction with respect to a boundary set on the rear side of a position that corresponds to the estimated disparity value.

To explain the above point in terms of distance, the disparity conversion method is changed to be different for an object present between an image pickup position 2402 of the main object and a nearest image pickup position 2408 and for an object present between the image pickup position 2402 of the main object and a farthest image pickup position 2407. In FIG. 24, the disparity conversion is not executed on the object present on the side nearer than the main object, while the disparity conversion is executed on the object present on the side farther than the main object such that the relationship between an image pickup distance and a reproduced distance becomes linear.

Stated in another way, a line 2401 in FIG. 24 represents the case where the disparity conversion is executed on the object present on the side farther than the main object so as to provide the relationship denoted by a linear line interconnecting an intersect point 2403 of a main object position 2402 and a minimum perceptual distance 2405 and an intersect point 2404 of a maximum image pickup distance 2407 and a maximum perceptual distance 2406. As a result, the perceived stereoscopic feel of the background, which is compressed in the original stereoscopic image, can be emphasized while the thickness of the main object is maintained.

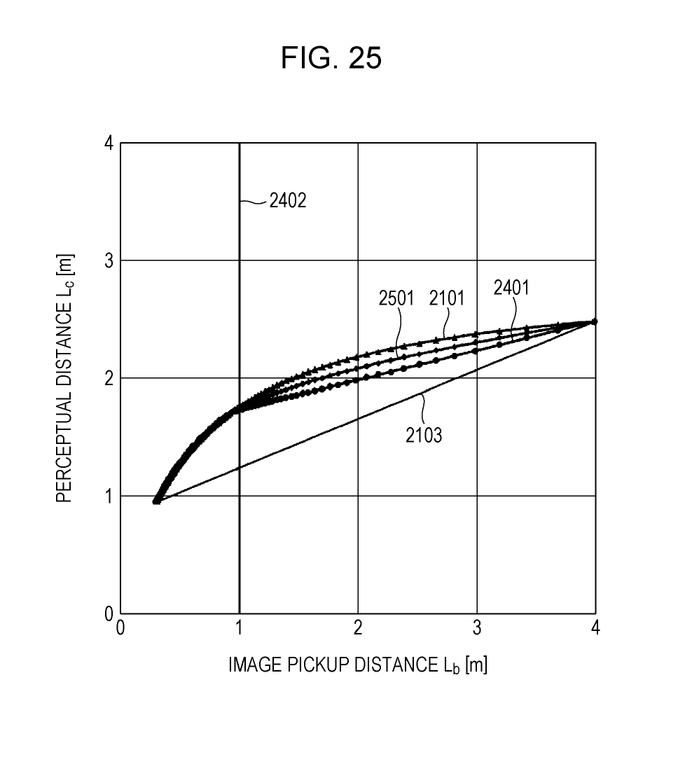

Moreover, it is preferable to define a characteristic of the disparity conversion with a weighed average of the perceptual curve 2101 and the line 2401, as plotted in FIG. 25, because the perceived stereoscopic feel of an object present on the side farther than the main object can be changed without changing the perceived stereoscopic feel of the main object by the user adjusting weighing parameters from the outside.

A line 2501 in FIG. 25 represents an example in which the perceptual curve 2101 and the line 2401 are weighed. When the weight applied to the perceptual curve 2101 is set to be relatively large, the disparity of an object near the background is compressed and the disparity of the foreground present on the side farther than the main object is enlarged. In other words, the spatial distortion, including the cardboard effect and the puppet theater effect, occurs. When the weight applied to the line 2401 is set to be relatively large, the disparity of an object near the background is enlarged and the disparity of the foreground present on the side farther than the main object is compressed. Thus, the spatial distortion is corrected, and the stereoscopic feel comes closer to that perceived with the actual space. With the characteristic calculated using the weighed average, therefore, the user can change the stereoscopic feel of the object present on the side farther than the main object in such a way as making it come closer to that of the actual space without impairing the stereoscopic feel of the main object in the photographed stereoscopic image, or as intentionally distorting a photographed space to emphasize the stereoscopic feel.

The above-described method can be combined with any of the methods described above in the second and third embodiments. The method of interpolating the enlarged disparity, i.e., the above-described process executed in the object structure correction portion in the first embodiment, can also be employed in the fourth embodiment.

The above-described embodiments are further applicable to an integrated circuit/chip set that is mounted on an image processing device.

### REFERENCE SIGNS LIST

1 . . . image display device, 2 . . . image pickup device, 10 . . . storage unit, 20 . . . information acquisition unit, 21 . . . stereoscopic image acquisition portion, 22 . . . disparity information acquisition portion, 23 . . . image-pickup condition acquisition portion, 24 . . . display condition holding portion, 30 . . . image processing unit, 31 . . . image generation portion, 32 . . . perceived position adjustment portion, 33 . . . object structure correction portion, 40 . . . display unit, 50 . . . image pickup unit, 51 . . . first image pickup unit, 52 . . . second image pickup unit, 500 . . . object-to-object distance, 1001 . . . input disparity, 1002 . . . output disparity, 1003 . . . disparity information, 1004 . . . disparity change point, 1100 . . . disparity information, 1101 . . . disparity information after disparity conversion, 1103 . . . preceding pixel, 1104 . . . disparity change point, 1105 . . . threshold, 1106 . . . pixel, 1107 . . . pixel, and 1108 . . . width.

1-11. (canceled)

12. An image processing device comprising an information acquisition unit that obtains disparity information calculated from a stereoscopic image; and
an image processing unit that converts a disparity of the stereoscopic image,
wherein when a difference between adjacent disparities contained in the disparity information is within a predetermined range and the difference between the adjacent disparity is increased in the disparity information after converting the disparity of the stereoscopic image, the image processing unit interpolates the disparity such that the difference between the adjacent disparities reduces.

13. The image processing device according to claim 12, wherein the conversion executed by the image processing unit compresses or enlarges the disparity of the stereoscopic image.

14. The image processing device according to claim 13, wherein the information acquisition unit further obtains image-pickup condition information when the stereoscopic image is taken, and display condition information of a display unit that displays the stereoscopic image, and
the image processing unit converts the disparity of the stereoscopic image in accordance with the mage-pickup condition information and the display condition information.

15. The image processing device according to claim 14, wherein the image processing unit reverses a direction of converting the disparity between when a binocular spacing contained in the display condition information is larger than a camera spacing contained in the image-pickup condition information and when the binocular spacing is smaller than the camera spacing.

16. The image processing device according to claim 14, wherein the predetermined range is given as a range between a disparity, which is calculated in accordance with the image-pickup condition information, the display condition information, and the disparity information, and an input disparity.

17. The image processing device according to claim 15, wherein the predetermined range is given as a range between a disparity, which is calculated in accordance with the image-pickup condition information, the display condition information, and the disparity information, and an input disparity.

18. The image processing device according to claim 16, wherein the disparity output through the disparity conversion is held within a range expressed by the disparity, which is calculated in accordance with the image-pickup condition information, the display condition information, and the disparity information, and by the input disparity.

19. The image processing device according to claim 17, wherein the disparity output through the disparity conversion is held within a range expressed by the disparity, which is calculated in accordance with the image-pickup condition information, the display condition information, and the disparity information, and by the input disparity.

20. The image processing device according to claim 18, wherein the image processing unit makes the disparity come close to 0 for an object present at a distance of a convergence point that is calculated from the image-pickup condition information.

21. The image processing device according to claim 19, wherein the image processing unit makes the disparity come close to 0 for an object present at a distance of a convergence point that is calculated from the image-pickup condition information.
